(19) United States
(12) Patent Application Publication
(10) Pub. No.: US 2008/0189190 A1
(43) Pub. Date: Aug. 7, 2008

(54) PROXY SERVER AND API EXTENSION FOR ONLINE STORES

(76) Inventor: Jeff Ferber, San Francisco, CA (US)

Correspondence Address: Zilka-Kotab, PC, P.O. BOX 721120, SAN JOSE, CA, 95172-1120, US

(21) Appl. No.: 12/019,442

(22) Filed: Jan. 24, 2008

Related U.S. Application Data
(60) Provisional application No. 60/898,976, filed on Feb. 1, 2007.

(51) Int. Cl. G06Q 30/00; G06F 3/048; G06F 17/30

(52) U.S. Cl. 705/26; 715/738; 715/234

(57) ABSTRACT

A system and method for populating an e-commerce shopping cart with product selections made by a different user according to one embodiment is presented. The method comprises permitting browsing of a third-party website by a first user; recording product selections made by the first user on the third party website; and populating a shopping cart of another user, program, or agent with products selected by the first user. A method for generating a textual and graphical representation of an e-commerce shopping cart according to another embodiment comprises receiving user input from a first user; generating a graphical representation of the shopping cart; and sharing the shopping cart with one or more other users. A method for inserting new functionality into existing e-commerce sites and sharing the content and functionality of these e-commerce sites with third-parties through an API.

### RELATED APPLICATIONS

This application claims priority to U.S. Provisional Patent Application Ser. No. 60/898,976, filed Feb. 1, 2007, and which is herein incorporated by reference.

### FIELD OF THE INVENTION

The present invention relates generally to systems and methods for electronic commerce (e-commerce), and more particularly relates to systems and methods for capturing, presenting, recreating, and sharing e-commerce activities.

### BACKGROUND OF THE INVENTION

Most online merchants do not have a satisfactory way to expose the functionality of their e-commerce stores for use by third-parties. Functionality commonly desired for integration with another website includes the capability to browse and search for products, to retrieve information for a product (e.g., images, price data, descriptions, in-stock status, reviews, etc.) and to link to or add the product to a shopping cart for subsequent customer purchase. However, no generally accepted standard or protocol for such behavior exists today. Some merchants, such as Amazon.com and Shopping.com, have independently developed their own application programming interfaces (APIs) for sharing some level of information and functionality, but this do-it-yourself approach is prohibitively expensive for most merchants.

The present invention provides a means to integrate the activities and content of e-commerce sites with other systems or entities in a manner requiring zero or only minor modifications to their existing infrastructure. Furthermore, it introduces important software features that the existing e-commerce sites may not already possess.

### SUMMARY OF THE INVENTION

A system and method for populating an e-commerce shopping cart with product selections made by a different user according to one embodiment is presented. The method comprises permitting browsing of a third-party website by a first user; recording product selections made by the first user on the third party website; and populating a shopping cart of another user, program, or agent with products selected by the first user.

A method for generating a textual and graphical representation of an e-commerce shopping cart according to another embodiment comprises receiving user input from a first user; generating a graphical representation of the shopping cart; and sharing the shopping cart with one or more other users.

A method for inserting new functionality into existing e-commerce sites and sharing the content and functionality of these e-commerce sites with third-parties through an API.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1 describes the core RemoteShopper application at a high level.

FIG. 2 describes “Proxy Mode” at a high level.

FIG. 3 describes Proxy Mode request and response interceptors.

FIG. 4 shows user interface controls inserted into an e-commerce website.

FIG. 5 shows a popup tutorial with dynamic html inserted into an e-commerce website

FIG. 6. describes Remote Tasks interacting with an e-commerce website

FIG. 7 shows a bundle of products selected from an e-commerce website

FIG. 8 shows a sampling of graphic representations of product selections

FIGS. 9-10 show a sampling a user emailing a shopping cart

FIG. 11 describes methods facilitating customer checkout

FIG. 12 describes an API exposing functionality for multiple e-commerce websites

### DETAILED DESCRIPTION

The following description is the best embodiment presently contemplated for carrying out the present invention. This description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

One embodiment of the present invention includes a system and method for recording product selections made by a user on a third-party e-commerce website, storing in a persistent state information to autonomously repopulate said products, generating textual and graphical representations of an e-commerce shopping cart, automating and facilitating the e-commerce checkout process, and sharing e-commerce content and functionality from multiple third-party e-commerce websites with other entities.

An exciting aspect of some embodiments of the present invention is a special proxy server that allows users to make product selections from one or more third-party merchant sites in a manner that can be recorded and later reintroduced into the third-party merchant's shopping cart by a different user. For example, a painter specializing in watercolors might select the materials and supplies they recommend for a beginner to get started. The painter, after selecting the recommended items, can then share with other people a graphic representation of their selections (on a web page, via email, etc.) Someone else viewing this recommendation can use the system to automatically populate their own e-commerce shopping cart containing the same list of recommended items, without having to browse or search for them individually. Similarly, one embodiment of the present invention can be used as a personal shopping tool. For example, Person A can select the items needed by Person B on one or more merchant websites, then use the system to email the choices to Person B who uses the system to facilitate a quick checkout.

In yet another embodiment, an application programming interface (API) exposes the content and functionality of multiple e-commerce sites in a manner permitting websites to integrate sophisticated e-commerce functionality into their own offering.

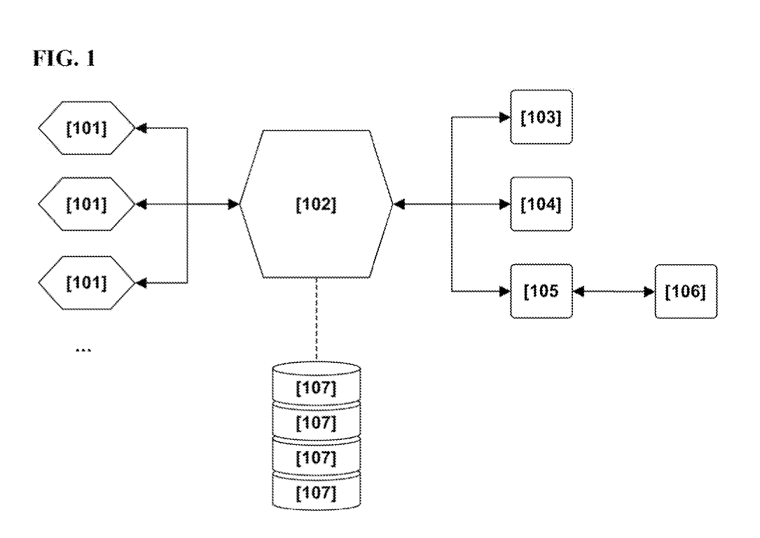

Particularly preferred embodiments include a proxy system, shown in FIG. 1. The RemoteShopper application 102, interacts with e-commerce sites 101 on behalf of users 103 and computer systems 104. Application programming interfaces (APIs) 105 expose the functionality of the RemoteShopper application 102 to other computer systems 106.

In a preferred embodiment, the RemoteShopper application 102 includes a java web application running on a cluster of servers with persistent storage and Internet access. Alternative embodiments of the RemoteShopper application 102 include a plug-in extension to a web-browser, a stand-alone software application (with or without GUI), a software library, or some other equivalent. The RemoteShopper application 102 is highly customizable, and its configuration 107 and functionality is addressed in greater detail later.

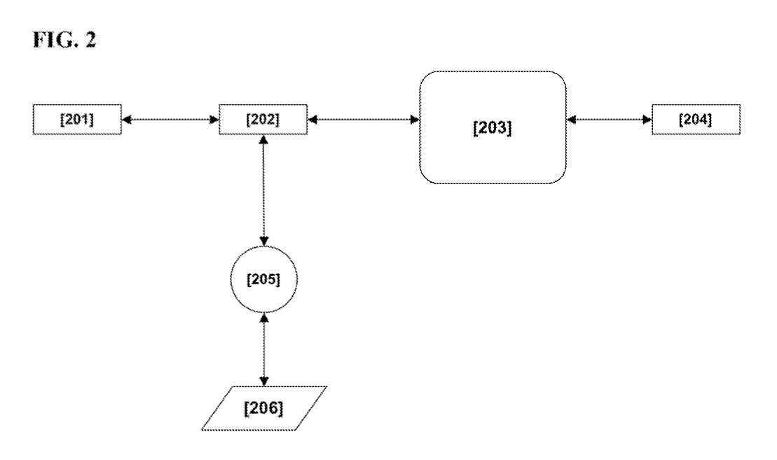

FIG. 2 describes a user 201 interacting with the RemoteShopper application 202 in “Proxy Mode”, for the purpose of displaying his product selections at a target destination 206. (A target destination might be an email message, a reply on an electronic forum, etc.) The user 201 interact with the RemoteShopper application 202, which correspondingly interacts with the merchant's e-commerce website 204 on behalf of the user 201. Consequently, the RemoteShopper application 202 has the opportunity to modify the http requests made by the user 201, to modify the http responses from the e-commerce website 204 to the user 201, and to perform additional requests or operations in between user 201 requests.

In a preferred embodiment, the user 201 visits a website served by the RemoteShopper application 202 and indicates which merchant store he or she wants to browse. Rather than linking the user directly to the merchant's e-commerce website 204, the proxy server 202 first creates a remote session 203. As the user 201 browses the e-commerce website 204 in this “Proxy Mode”, the remote session 203 is used to track relevant information, some of which is stored in persistent storage 206. It tracks http cookies to preserve client state, internal status codes, and any other data that should be associated with the scope of the user session.

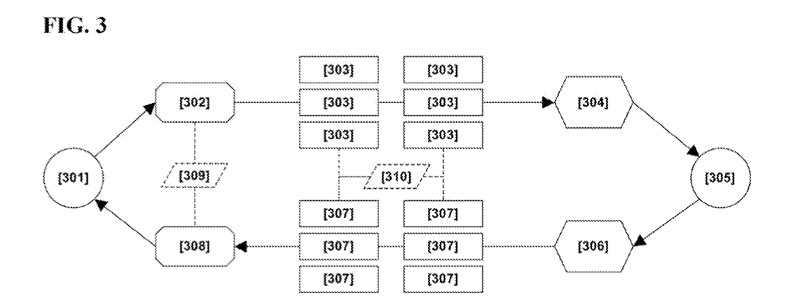

Transactions between the RemoteShopper application 202 and the merchant's e-commerce website 204 and between the RemoteShopper application 202 and the user 201 undergoes processing as described in FIG. 3.

An incoming http request from the user 301 is first parsed 302 to identify what remote session 309 is associated with the request and what URL is desired at the destination e-commerce site 305. In a preferred embodiment, an identifier for the remote session 309 is inserted into the URLs contained in the http response 306 returned from the e-commerce site 305, so that when the user 301 clicks a link, their new request contains the identifier. The identifier is included as a subdomain, so web browsers conveniently include the identifier automatically when they encounter relative links/hypertext references. A preferred embodiment supports multiple sessions for the same user visiting different e-commerce sites 305 simultaneously. Alternative embodiments might associate the identifier with requests in other ways, such as by I.P. address, http cookie, authentication credentials, etc.

Next, a series of request interceptors 303 act on the http request, as controlled by a highly flexible configuration system 310. Each request interceptor 303 can modify the request, drop the request and instead generate a redirect response, persistently save relevant information, or perform alternative programmatic processing based on information in or associated with the http request, user 301, e-commerce site 305, or remote session 309.

In a preferred embodiment, each time the user 301 adds products to their shopping cart on the e-commerce site 305 one of the request interceptors 303 will recognize that an add-to-cart event is taking place, based upon information contained in the request, such as a post parameter, request URL, or other characteristic of the request as controlled by the merchant-specific configuration 310. When this event is triggered, the interceptor passes along the request information to a merchant-specific configurable script that filters and persistently saves the relevant portions of the request such that the add-to-cart command can be subsequently re-issued by the present invention, even for a different user 301.

Request interceptors 303 can be applied to any scope. They can be applied or customized to the target e-commerce site 305, to a specific user 301 or group of users, etc. Any aspect of the http request can trigger the request interceptor 303 to execute, and when run, it can perform a large range of functions.

For example, a request interceptor 303 is used in a preferred embodiment to improve the user experience when the user 301 is browsing the target e-commerce site 305 with the declared goal of importing products. The remote session 309 contains a status code indicating the user has an IMPORT goal (versus CHECKOUT or some other declared goal.) If the user clicks a “checkout now” button, a request interceptor 303 redirects the user 301 away from the e-commerce site 305, taking him instead to a page intended to handle the next step following product import.

Other request interceptors are used in a preferred embodiment to log problems, check for abuse, etc.

If the request interceptors 303 finish without having sent an http response directly to the user 301, a new http request will be issued 304 from the RemoteShopper application to the target e-commerce site 305. The corresponding http response 306 will be processed by a series of response interceptors 307, as controlled by the highly flexible configuration system 310. The resulting, modified, http response will be sent 308 from the RemoteShopper to the user 301.

In a preferred embodiment, response interceptors 307 are used to insert content and functionality into the e-commerce site 305, monitor when a purchase is successfully finished, and for a variety of additional tasks.

One task of the response interceptors 307 is to modify URLs/hyperlink references contained with the http response body when appropriate (again determined by the configuration system 310.) Links that would take the user 301 away from the RemoteShopper's host server may be modified when this behavior is undesirable. In a preferred embodiment of the present invention, response interceptors 307 modify these URLs such that if/when followed, the generated http request 1) points to the server hosting the RemoteShopper application; 2) can be parsed 302 to reveal the associated remote session 309 identifier; 3) can be parsed 302 to reveal desired URL at the destination e-commerce site 305; and 4) preserves all information carried by the unmodified request, along with some new information added.

For example, if the original http response 306 contains a link to http://www.example.com/store/browse?products=cats it might be transformed into http://1234.remote.plurchase.com/store/browse?products=cats by a response interceptor 307. In this example, example.com is the domain of the e-commerce site 305. In this example, the user 301, never leaves the domain plurchase.com, the site running the RemoteShopper application of the present invention. The modified http response that is sent 308 to the user 301 continues to keep the user on plurchase.com. If the link is followed, it generates an http request in a format that can parsed 302 to determine the remote session 309 is, in this case, 1234, as well as other information specific to the http request, in this case the path and query string. The target URL at the destination e-commerce site 305 can then be recreated using information associated with the remote session 309, that #1234 is associated with the e-commerce site 305 example.com.

Additional information may be added, as part of the http request, such as in a request parameter. In a preferred embodiment, a request parameter is sometimes added to the http query string to more accurately describe the desired domain or subdomain.

Like request interceptors 303, response interceptors 307 can be applied to any scope, can perform a large range of functions.

In a preferred embodiment, a framework for creating and maintaining interceptors is used to provide a highly flexible “toolbox” for creating merchant-specific configurations 310 to quickly apply and customize request interceptors 303 and response interceptors 307. This framework takes advantage of modern programming techniques to quickly achieve desired functionality. Alternative embodiments might employ any variety of functional, procedural, or object-oriented programming, etc., to achieve the described results.

Alternative embodiments of the present invention may use differing systems to enable proxy functionality or to inject interceptors or watchers. This includes a range of options, such as an apache proxy server, a packet sniffer application monitoring web activity, any system for conveying identifying information within requests, a custom web browser or browser plug-in or extension, etc.

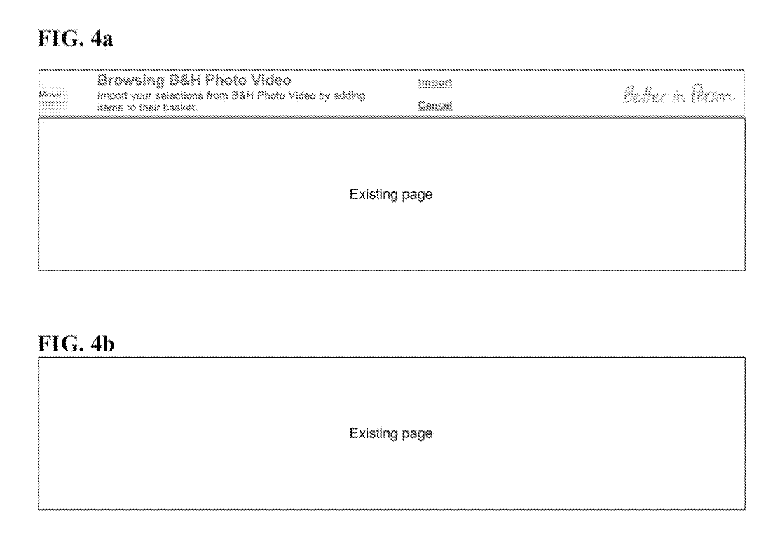

FIG. 4a shows a partial screenshot of a preferred embodiment that uses a response interceptor to insert a control bar into the top of a merchant website to provide a better usability experience for users importing products from a merchant's e-commerce pages. FIG. 4b shows the same page without intervention by the response interceptor.

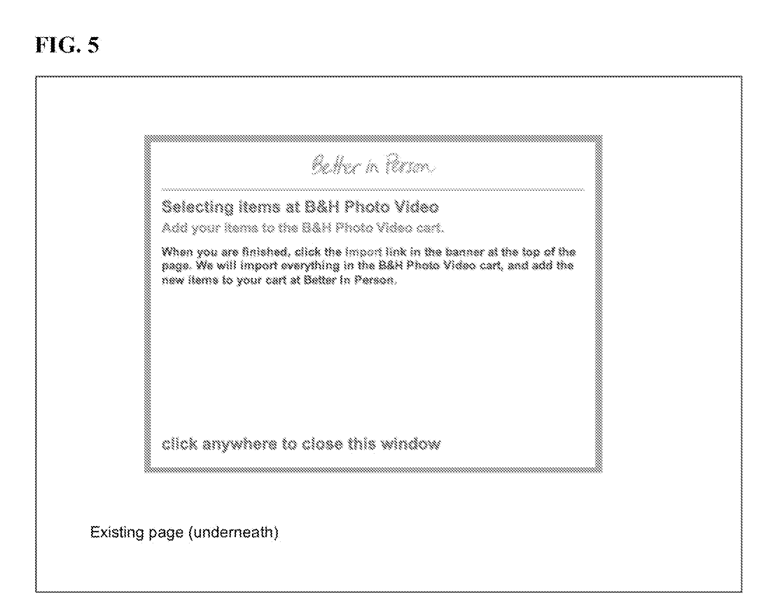

FIG. 5 shows a popup page inserted into the original http response, used as a tutorial for new users.

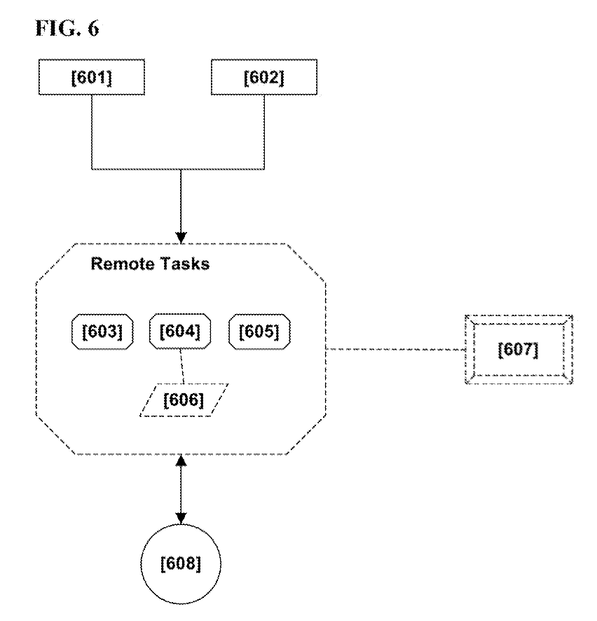

FIG. 6 describes the interaction between the RemoteShopper application and an e-commerce site 608 for activities other than serving user requests in Proxy Mode.

Remote Tasks 603-605 are initiated by Events 601 or by recurring Producers 602, which run on a delay or a schedule. Remote Tasks interact with one or more e-commerce site 608 for the purpose of extracting data or running functionality.

Remote Tasks 603-605 can be configured to use nearly any feature offered on an e-commerce site 608, to extract data or to replicate an activity that a user might perform. A Remote Task 603-605 can be created for immediate execution, background execution, or delayed or scheduled execution. If configured to do so, remote tasks 603-605 can authenticate as a specific user and can preserve client state and http cookies.

Scraping-related tasks 603 are a set of remote tasks that, in a preferred embodiment, are employed to extract content from the e-commerce site 608. In a preferred embodiment, recurring Producers 602 initiate scheduled scraping-related tasks 603 to check for information deemed relevant such as price changes and product inventory status, usually scheduled to occur during off-peak times. Scraping-related tasks 603 are used to interact with the e-commerce site 608 when the user is not in visiting it in Proxy Mode. For example, order status can be displayed to the user at a website external to the e-commerce site 608.

A scraping-related task 603 is used in a preferred embodiment to execute a user search query on one or more e-commerce sites 608. Using scraping-related tasks 603, individual searches are performed using the search functionality native to the e-commerce site 608, or if preferred, some other search engine. Whereupon the results of the search are scraped and re-presented to the user, possibly with further scraping-related tasks 603 used to extract more detailed information (e.g., such as shipping costs.) in this manner, multiple merchant stores can be searched, with consolidated results displayed to the user.

A scraping-related task 603 is used in a preferred embodiment to extract product information (price, images, etc.) from an e-commerce site 608 in the background to allow the present invention to display representations of product selections external to the e-commerce sites 608. A variety of triggers can be configured to cause an event 601 to begin a scraping-related task 603 to extract this content. For example, an event 601 can be configured on a per-merchant scope to occur when a user navigates to a “view shopping cart” page containing the product, when a user signals they are finished selecting the product, when a user adds the product to a cart, and/or when a user views a product detail page.

Agent-related tasks 604 are a set of remote tasks that are associated with a remote session 606. The http activities of an agent-related task 604 become part of the client state, which, among other things, means http cookies received from the e-commerce site 608 will be persisted and associated with the associated remote session 606. As described in a previous section, remote sessions 606 are used to support Proxy Mode. Thus, an agent-related task 604 can automate activities before, during, or after a user visits an e-commerce site 608 in Proxy Mode, allowing agent-related tasks 604 to seamlessly do work on behalf of a user.

In a preferred embodiment of the present invention, an important agent-related task 604 is used to recreate a shopping cart for a user with products originally selected by a different user, described later in further detail.

An API-related task 605 is used when an e-commerce site 608 provides an API for extracting content or calling functionality. If content and functionality is offered by an e-commerce site 608 through an API or some other electronic system such as an XML feed, it may be more efficient or otherwise suitable to use an API-related task than another Remote Task described above.

A remote task framework 607 is used to flexibly create, maintain, or enhance Remote Tasks 603-605. A variety of well established techniques and technologies for text manipulation are used in a preferred embodiment, such as XPath, Regular Expressions, XQuery, and XSLT. In a preferred embodiment, these are incorporated into a scripting environment that allows the configuration of the Remote Tasks 603-605 using a variety of programming tools and commands, such as conditional branching, loops, variables, database queries, function calls, macros, helper methods, templating, etc. In alternative embodiments, other techniques can be used to manipulate or interact with e-commerce sites 608, such as PERL programs, XML-based frameworks for scraping, or any other programmatic means to send, receive, and evaluate http or other data.

In a preferred embodiment of the present invention, in addition to the techniques described above, product-related information (such as images, descriptions, price, etc.) and other website content can be retrieved and stored using other methods, aggregated from syndicated feed, supported xml schema, import or upload, and/or manual entry.

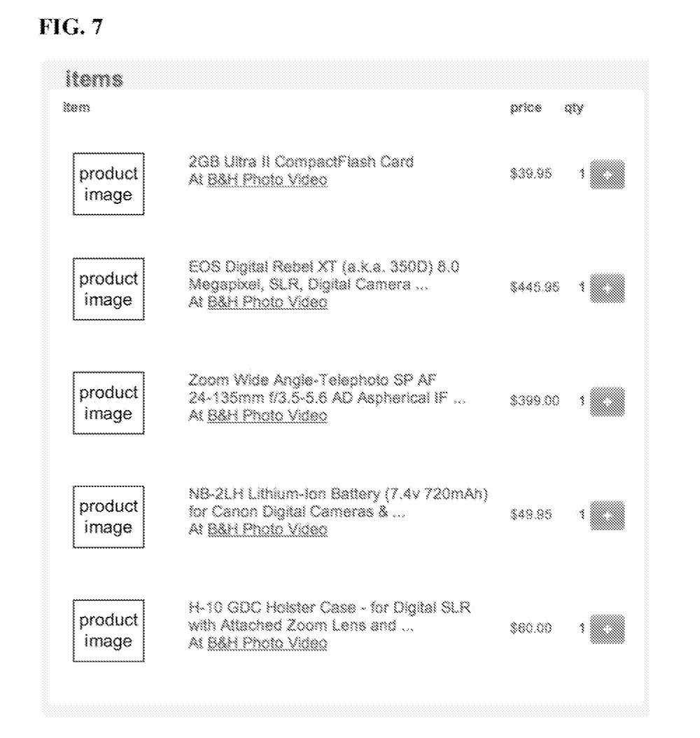

FIGS. 7-10 show sample graphical representations of product selections. The present invention allows users to visually enhance product selections, add personal notes, transfer ownership, and share the results with others.

FIG. 7 shows a preferred embodiment in which a user creates a product bundle from the products selected at an e-commerce site.

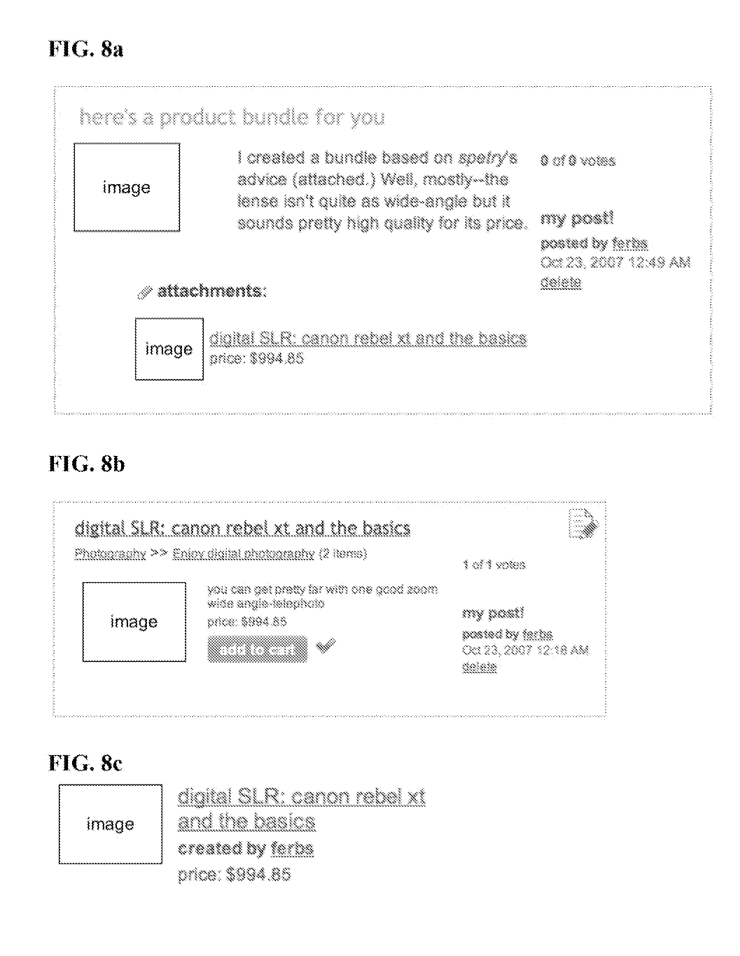

FIG. 8a shows the user's product selections embedded as an attachment in the context of an inline post on a community bulletin board/forum.

FIG. 8b shows the user's product selections in a summary view.

FIG. 8c shows the selections in a format suitable for sharing on a blog or website.

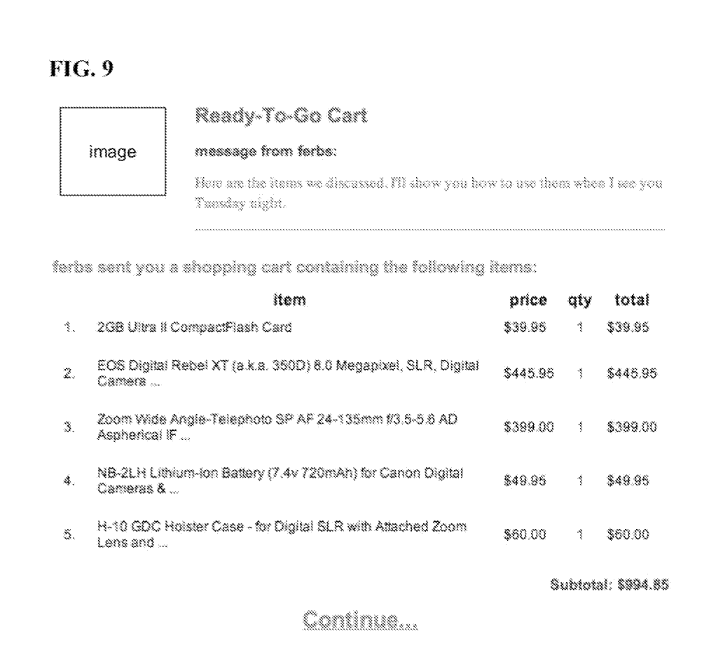

FIG. 9 shows a preferred embodiment which can be used to send product recommendations by email.

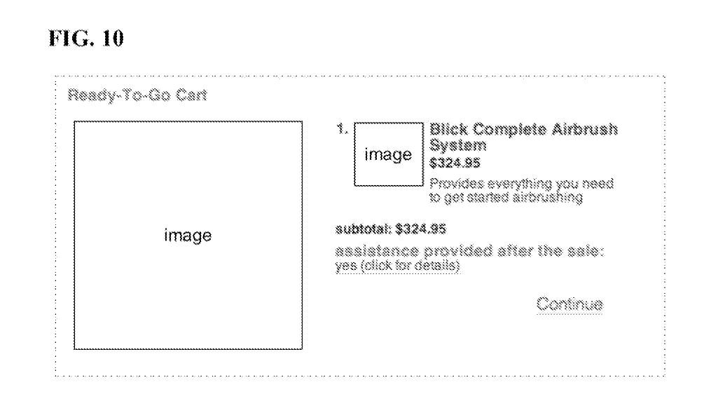

FIG. 10 shows a preferred embodiment which can be used to advertise on a blog or website post-sales service relating to a collection of products.

In a preferred embodiment, web-based software provides functionality for:
Providing system-selected or user-selected textual and graphical templates to visually or materially improve the content;
Providing drawing, layout, graphic, import, and editing tools for customizing the look and feel;
Providing communication tools to let the user add text, audio (including personal voice message), or video (including video of user A, perhaps using the product) to the work. Can also include links to such information;
Freezing system or human-determined areas to prevent the modification of protected sections or assets (e.g., to protect copyright artwork that is not licensed for modification);
Modifying product selections and quantities, or optionally initiating a new shopping session that begins with the current selections in the merchant's shopping cart;
Setting access rights to determine who can view the work (includes creating list of authorized users, access keys, etc.);
Tracking the creator's identity for subsequent artistic or commercial credit;
Formatting the work as an email and sending it using standard email protocols, or alternatively, sending an email invitation to view work online, where email may include a pass code to access the work or link directly thereto;
Formatting the work in electronic format such as html or PDF for posting on a website or blog, mailing by email or shared viewing on a server which may be remote to one or more of the parties;
Embedding product-specific, system-determined, or user-determined hyperlinks within the shared work;
Transferring ownership of the work and/or the original e-commerce shopping cart items for subsequent purchase or creative modification by another user;
Security features for allowing user B to restrict or prevent future access to the work by user A
Sharing the work/cart for continued collaborative inclusion of more items;

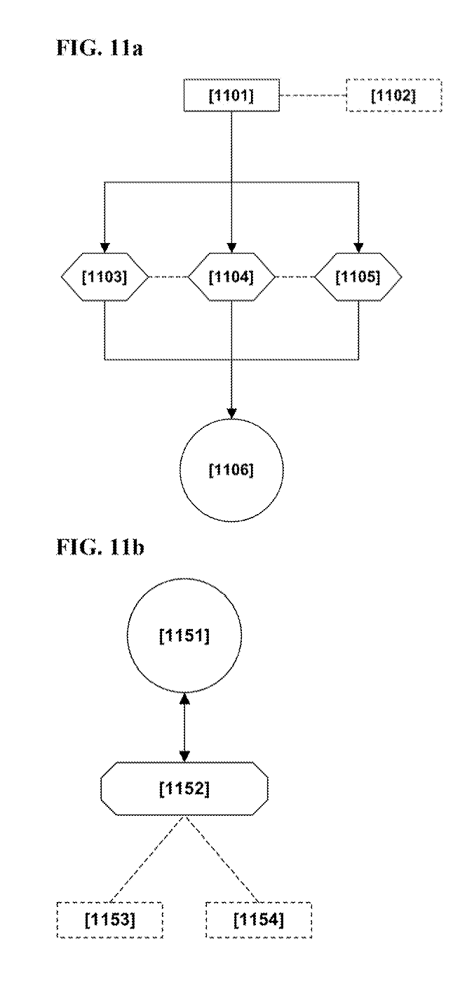

FIGS. 11a and 11b describe the facilitation of the e-commerce checkout process in a preferred embodiment.

In a preferred embodiment of the present invention, a user navigates to a checkout page 1101 listing one or more products 1102 that are desired for purchase. The products 1102 may correspond to more than one e-commerce site 1106. A variety of methods are employed to facilitate the checkout process.

Cart-population methods 1103 are used to automate add-to-cart activities. As described earlier, a preferred embodiment of the present invention records the steps and http requests required to add a given product to its corresponding e-commerce site 1106. In a matter of speaking, the system learns from the users how to add a product to its corresponding shopping cart.

When a cart-population method 1103 is used to facilitate the checkout process for a user, a Remote Task may be used to do so. In one illustrative approach, an agent-related task 1152 creates a new remote session 1153. Next, it retrieves all relevant information from persistent storage 1154 that is needed to recreate the add-to-cart http requests needed for the relevant products. Then, it issues one or more http requests to the e-commerce site 1151, as configured for the specific merchant, adding the relevant products to the shopping cart while keeping http cookies and client state associated with the newly created remote session 1153. Finally, the user is sent to the e-commerce site 1151 in Proxy Mode, using these same http cookies and client state preserved by remote session 1153. As a result, all the products will be in the user's shopping cart at the e-commerce site 1151, added automatically on the user's behalf.

Form-completion methods 1104 are used to automate form entry, multi-page wizards, and other types of data collection commonly used on the e-commerce sites 1151. A preferred embodiment of the present invention collects pertinent user information in advance, such as contact and billing information, then uses Remote Tasks to perform all necessary transactions on the user's behalf.

API-facilitation methods 1105 are used when an e-commerce site 1151 provides checkout-related functionality. If so, an API-facilitation method might be more efficient or otherwise appropriate than another method.

These checkout methods 1103-1105 can be combined or used separately, can be specially configured for e-commerce sites 1151 and users, and employment can vary depending on the number of merchants involved, the specific merchants involved, and user preference.

If the products 1102 correspond to more than one merchant e-commerce site 1106, a variety of techniques can facilitate the checkout. In a preferred embodiment of the present invention, checkout methods 1103-1105 are combined such that the shopping cart for each merchant e-commerce site 1106 is first populated with the appropriate products. Then, form-completion methods are used to continue through most or all of the checkout process on behalf of the user, submitting billing information, shipping address, etc. If a problem is encountered, or if it is configured to stop before completing product checkout, the user is taken to the e-commerce site 1106 in Proxy Mode. While there, request and response interceptors (described earlier) insert status information and insert user interface controls allowing the user to provide instructions, such as skipping to the next step of the process.

In a preferred embodiment, checkout methods 1103-1105 are used to offer a feature for users wishing to make recurring purchases. For example, a business might order the same type of consumable supplies every month. In a preferred embodiment, these checkout methods 1103-1105 are combined to offer a time-saving feature that displays past purchases and/or saved lists of products, collects new quantity values for these products, and then automates the checkout process.

In a preferred embodiment, request interceptors and response interceptors monitor the checkout process for purchase status. In particular, it monitors for the successful completion of a purchase. This information is stored and can be used to track affiliate relationships, revenue-sharing credits, for allocating credit to the entity originating the sale, or for some other purpose.

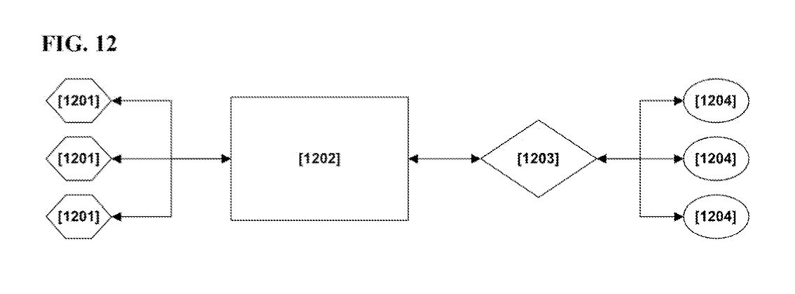

FIG. 12 describes an API system where the functionality and content of one or multiple e-commerce sites 1201 can be exposed to third-party entities 1204. In a preferred embodiment, third-party entities 1204 interact through an API 1203 with a web-based server 1202 running the present invention.

The API 1203 exposes functionality of the present invention, including the ability for users to select products from any of the configured e-commerce sites 1201, to represent product selections graphically, to execute select Remote Tasks, and to facilitate checkout for selected products.

For example, a third-party entity 1204 can use the API to let users create a product registry or birthday wish-list. Instead of being limited to a single store, the hopeful recipient picks products from any e-commerce sites 1201. The API 1203 assists the third-party entity 1204 to graphically display and/or share the product selections, and then can facilitate the checkout process.

The description herein is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in which one embodiment of the invention may be executed illustratively incorporates one or more general-purpose computers or special-purpose devices such hand-held computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing either a combination of microprocessors or other specially designed application specific integrated circuits, programmable logic devices, or various combinations thereof. In particular, methods described herein may be implemented by a series of computer-executable instructions residing on a storage medium such as a carrier wave, disk drive, or computer-readable medium. Exemplary forms of carrier waves may be electrical, electromagnetic or optical signals conveying digital data streams along a local network or a publicly accessible network such as the Internet. In addition, although specific embodiments of the invention may employ object-oriented software programming concepts, the invention is not so limited and is easily adapted to employ other forms of directing the operation of a computer.

The invention can also be provided in the form of a computer program product comprising a computer readable medium having computer code thereon. A computer readable medium can include any medium capable of storing computer code thereon for use by a computer, including optical media such as read only and writeable CD and DVD, magnetic memory, semiconductor memory (e.g., FLASH memory and other portable memory cards, etc.), etc. Further, such software can be downloadable or otherwise transferable from one computing device to another via network, wireless link, nonvolatile memory device, etc.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for populating an e-commerce shopping cart with product selections made by a different user, the method comprising:
permitting browsing of a third-party website by a first user;
recording product selections made by the first user on the third party website; and
populating a shopping cart of another user, program, or agent with products selected by the first user.

2. The method of claim 1, further comprising sending at least some of the product selections to a target destination.

3. The method of claim 1, wherein the target destination is an email address of the another user.

4. The method of claim 1, further comprising modifying requests made by the user during browsing the third party websites, and sending the modified requests to the third party websites.

5. The method of claim 1, further comprising tracking non-product-related information during the browsing of the third party websites.

6. A method for generating a textual and graphical representation of an e-commerce shopping cart, comprising:
receiving user input from a first user;
generating a graphical representation of the shopping cart; and
sharing the shopping cart with one or more other users.

7. A system comprising:
logic for permitting browsing of third-party websites;
logic for recording product selections made by a first user on one or more of the third party websites;
logic for populating a shopping cart of another user, program, or agent with products selected by the first user.

8. A method for adding functionality to a web page of an existing website, comprising:
receiving user input;
interacting with a website on behalf of the user based on the user input;
receiving a web page from the website;
modifying the web page; and
presenting the modified web page to the user.

9. The method of claim 8, wherein the existing website is an e-commerce site.

10. The method of claim 8, further comprising sharing at least a portion of the modified web page with a third party.

11. The method of claim 8, wherein the web page is modified to include additional content and functionality.
